(19) United States
(12) Patent Application Publication
(10) Pub. No.: US 2007/0158116 A1
(43) Pub. Date: Jul. 12, 2007

(54) Adjustable steering column assembly

(75) Inventor: Steven A. Peppler, Mulberry, IN (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive U.S. LLC

(21) Appl. No.: 11/330,558

(22) Filed: Jan. 12, 2006

(51) Int. Cl. G01G 9/00; G01G 19/52; B60K 28/00

(52) U.S. Cl. 177/1; 177/144; 180/273

(57) ABSTRACT

An apparatus (10) for adjusting the position of a steering wheel (16) includes an actuating system (22) operatively connected to the steering column assembly (18) for adjusting the position of a steering wheel (16). The actuating system (22) is operable to move the steering wheel (16) along a central axis of the steering column assembly (18) and operable to tilt the steering wheel relative to the central axis of the steering column assembly (18). The apparatus further includes at least one weight sensor (102) operatively associated with a driver's seat (100) for sensing a driver's weight on the seat. The weight sensor (102) outputs a signal which is a function of the sensed weight. The apparatus includes a controller (54) that receives the signal and outputs a control signal to the actuating system (22) to adjust the position of the steering wheel (16) based on the weight on the seat (100).

### TECHNICAL FIELD

The present invention relates to an adjustable steering column assembly.

### BACKGROUND OF THE INVENTION

A known steering column assembly has tilt and telescope adjustment features. This known steering column assembly is provided with a motor which is operated by a driver of a vehicle. Operation of the motor varies the telescopic relationship between inner and outer steering column members, which varies the axial position of a steering wheel.

Also, the known steering column assembly is actuatable by the driver of the vehicle to operate a second motor. Operation of the second motor varies the tilt of an upper portion of the steering column assembly and thus varies the tilt of a steering wheel relative to the steering column assembly.

### SUMMARY OF THE INVENTION

The present invention relates to an apparatus for adjusting the position of a steering wheel. The apparatus includes an actuating system operatively connected to a steering column assembly. The actuating system is operable to adjust the steering column assembly and change the position of the steering wheel. The actuating system is operable to move the steering wheel along a central axis of the steering column assembly and is operable to pivot the steering wheel relative to the central axis of the steering column assembly to tilt the steering wheel.

The apparatus further includes at least one weight sensor operatively associated with a driver's seat for sensing a driver's weight on the seat. The weight sensor outputs a signal which is a function of the driver's weight. A controller is operatively connected to the weight sensor and the actuating system. The controller receives the signal and outputs a control signal to the actuating system to adjust the steering column assembly to change the position of the steering wheel as a function of a signal from the weight sensor.

### BRIEF DESCRIPTION OF THE DRAWINGS

The foregoing and other features of the present invention will become apparent to one skilled in the art upon reading the following description of the present invention with reference to the accompanying drawings, wherein:

FIG. 1 is a schematic illustration of an apparatus for use in steering a vehicle;

FIG. 2 is a schematic illustration of an adjustable steering column assembly utilized in the apparatus of FIG. 1;

FIG. 3 is a schematic pictorial illustration of one embodiment of the steering column assembly of FIG. 2; and

FIG. 4 is a schematic side elevational view, taken generally along the line 4-4 of FIG. 3, further illustrating the construction of the steering column assembly.

### DESCRIPTION OF PREFERRED EMBODIMENTS OF THE INVENTION

An apparatus 10 for use in turning steerable vehicle wheels 12 and 14 is illustrated in FIG. 1. The apparatus 10 includes a steering wheel 16 which is connected with an adjustable steering column assembly 18 (FIGS. 1-4). The steering wheel 16 is connected to an upper steering column member 42. A steering gear 20 (FIG. 1) connects the steering column assembly 18 with the steerable vehicle wheels 12 and 14. The steering gear 20 is of any suitable type such as the well-known power rack and pinion gear type. Also for example, the steering gear 20 may be a manual steering gear rather than a power steering gear. As another example, the steering gear 20 may be an integral hydraulic power steering gear or an electric motor powered steering gear.

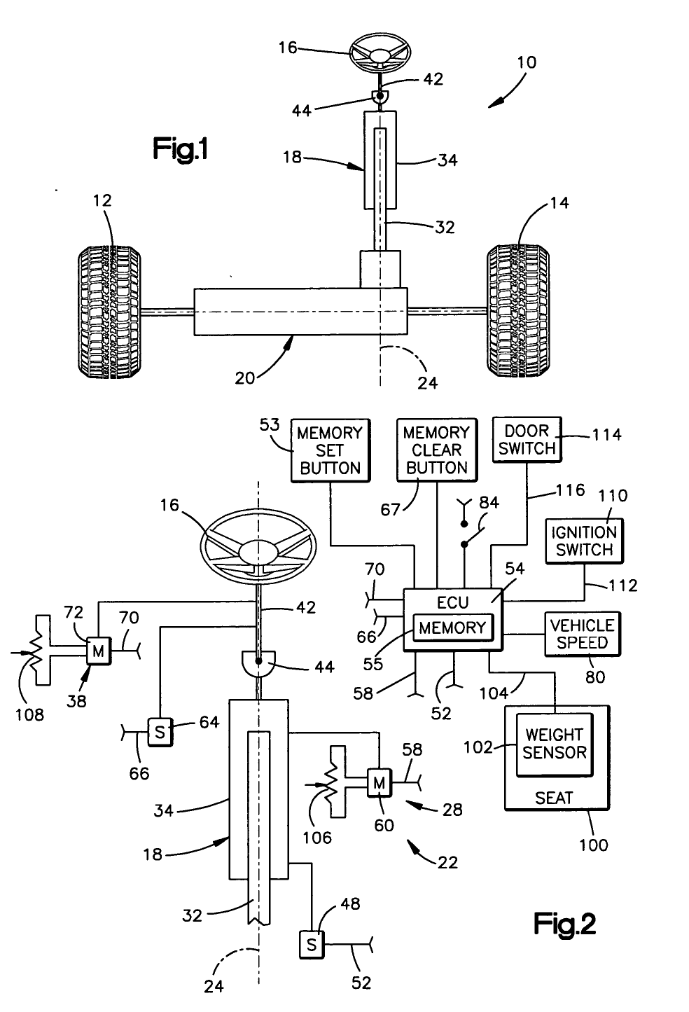

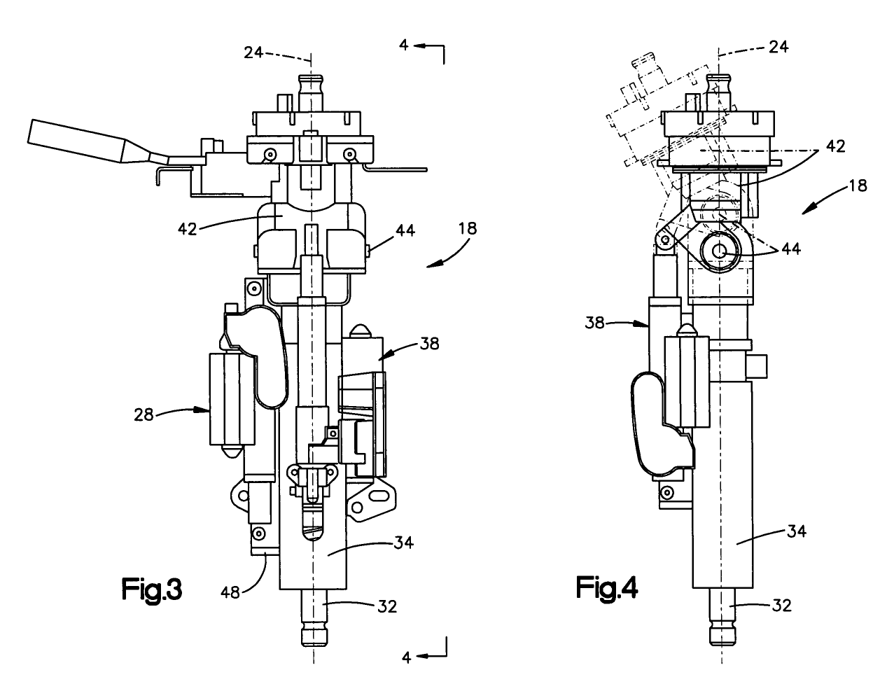

An actuating system 22 is operable to adjust the steering column assembly 18 and the position of the steering wheel 16. The actuating system 22 includes a first or telescope actuator 28 (FIGS. 2 and 3) which is operated to vary the telescopic relationship between inner and outer members 32 and 34 of the adjustable steering column assembly 18. When the telescopic relationship between the inner and outer members 32 and 34 is to be varied, the outer member 34 is moved relative to the inner member 32. However, the steering column assembly 18 may be constructed so that the inner member 32 is moved relative to the outer member 34 when their telescopic relationship is to be varied. A change in the telescopic relationship between the inner and outer members 32 and 34 moves the steering wheel 16 either toward or away from a driver of the vehicle.

When force is manually applied to the steering wheel 16 in a direction to tilt the steering wheel 16 relative to the central axis 24 of the steering column assembly 18, a second or tilt actuator 38 (FIGS. 2, 3 and 4) in the actuating system 22 is operated to pivot the upper steering column member 42 about a pivot joint 44. When the upper steering column member 42 is pivoted, the angular orientation of the steering wheel 16 relative to the longitudinal central axis of the steering column assembly 18 is varied. This effects a change in the angular orientation or tilt of the steering wheel 16 relative to a driver of the vehicle. FIG. 4 illustrates one position of the upper steering column member 42 and the outer member 34, and another position in phantom of the upper steering column member 42 and outer member 34, which resulted in the upper steering column member 42 being pivoted about the pivot joint 44 and the outer member 34 being moved relative to the inner member 32.

The actuators 28 and 38 may be simultaneously operated to simultaneously affect both tilt and telescopic adjustment of the steering wheel 16. Alternatively, the actuators 28 and 38 may be sequentially operated to sequentially affect tilt and telescopic adjustment of the steering wheel 16. Of course only telescopic or tilt adjustment of the steering wheel 16 may be obtained by operating only one of the actuators 28 and 38.

In the embodiment of the invention illustrated in FIGS. 1-4, force is manually applied to the steering wheel 16 to vary: (1) the position of the steering wheel along the longitudinal central axis 24 of the steering column assembly 18 and/or (2) the angular orientation of the steering wheel relative to the longitudinal central axis of the steering column assembly.

When the actuators 28 and 38 are not being operated, they are effective to prevent either tilt or telescopic adjustment of the steering wheel 16. When the telescope actuator 28 is not being operated, the inner and outer members 32 and 34 are held against telescopic movement relative to each other. Similarly, when the tilt actuator 38 is not being operated, the upper steering column member 42 is held against pivotal movement at the pivot joint 44.

When a driver of a vehicle wishes to change the position of the steering wheel 16 along the longitudinal central axis 24 of the steering column assembly 18, the driver manually applies force to the steering wheel 16 (FIG. 2) to either push or pull the steering wheel. The manual application of force to the steering wheel 16 in a direction which extends along the longitudinal central axis 24 of the steering column 18 is detected by a force sensor 48 (FIGS. 2 and 3) which is connected to the outer member 34 of the steering column 18. The force sensor 48 is a load cell which provides an output signal along a lead 52 (FIG. 2) to an electronic control unit 54.

In response to the signal from the force sensor 48, the electronic control unit 54 (FIG. 2) provides an output signal over a lead 58 to energize a reversible electric motor 60 in the telescope actuator 28. The motor 60 is then operated to effect movement of the outer member 34 along the longitudinal central axis 24 of the steering column 18. Operation of the motor 60 effects movement of the steering wheel 16 in a direction either toward the operator of the vehicle or away from the operator of the vehicle depending upon the direction of the force which is manually applied to the steering wheel 16 by the operator of the vehicle.

If the operator manually applies the force to the steering wheel 16 pulling the steering wheel upward or toward himself, the motor 60 is operated in one direction to move the outer member 34 and steering wheel 16 upward (as viewed in FIGS. 1-4) toward the operator. Similarly, if the operator manually applies force to the steering wheel 16 pushing the steering wheel away from himself, the motor 60 is operated in the opposite direction to move the outer member 34 and steering wheel downward along the longitudinal central axis 24 of the steering column assembly 18.

The motor 60 in the telescope actuator 28 is a reversible electric motor. However, if desired, a reversible hydraulic or pneumatic motor may be utilized.

A force sensor 64 (FIG. 2) is provided to detect the manual application of force to the steering wheel in a direction that tilts the steering wheel 16 relative to the central axis 24 of the steering column assembly 18. The sensor 64 is connected with the upper steering column member 42 (FIGS. 2, 3 and 4). Upon manual application of force to the steering wheel 16 (FIG. 2) in a direction that tilts the steering wheel 16 relative to the central axis 24 of the steering column assembly 18, the sensor 64 provides an output over a lead 66 to the electronic control unit 54.

In response to a signal over the lead 66, the electronic control unit 54 (FIG. 2) transmits a signal over a lead 70 to energize a reversible electric motor 72 in the actuator 38. Upon operation of the motor 72, the upper steering column member 32 and steering wheel 16 are pivoted together about the connection 44 to change the angular orientation of the steering wheel 16 relative to the longitudinal central axis 24 of the steering column 18. Depending upon whether the force applied to the steering wheel 16 in a direction toward or away from the operator, the reversible electric motor 72 is operated to either tilt the steering wheel 16 toward the operator or to tilt the steering wheel away from the operator.

The motor 72 in the tilt actuator is a reversible electric motor. However, if desired, a reversible hydraulic or pneumatic motor may be utilized.

The sensors 60 and 64 are load cells which measure force transmitted from the steering wheel 16 to a component of the steering column assembly 18. Thus, the force sensor 48 is a load cell which measures force transmitted from the steering wheel 16 to the outer member 34 of the steering column assembly in a direction along the longitudinal central axis 24 of the steering column assembly. Similarly, the force sensor 64 measures force transmitted from the steering wheel to the upper steering column member 42 in a direction that tilts the steering wheel 16 relative to the central axis 24 of the steering column assembly 18.

The load cells of the force sensors 48 and 64 contain strain gauges having an output which varies as a function of the magnitude of the force which is manually applied to the steering wheel 16.

Alternatively, the force sensors 48 and 64 may include load cells containing piezoelectric devices having output signals which vary as a function of the magnitude of the force which is manually applied to the steering wheel 16. Of course, other known force sensors may be utilized.

It is contemplated that tilt and/or telescope adjustments will be applied to the steering column assembly 18 when the vehicle in which the steering column assembly is disposed is stopped. Therefore, a vehicle speed sensor 80 is connected with the electronic control unit 54. The electronic control unit 54 affects operation of one or both of the reversible electric motors 60 and 72 to adjust the position of the steering wheel 16 relative to the occupant of the vehicle only when the vehicle is stopped. If desired, a sensor which detects when a transmission of the vehicle is in park may be substituted for the speed sensor.

In order to prevent inadvertent changing of the orientation of the steering wheel 16 by an operator of a vehicle, a control switch 84 is connected with the electronic control unit 54. The control switch 84 must be actuated before the electronic control unit 54 affects operation of either the motor 60 in the telescope actuator 28 or the motor 72 in the tilt actuator 38 when the vehicle is stopped. If desired, the manually actuated control switch 84 may be omitted.

When the vehicle is being driven along the road by an operator of the vehicle, the operator may rotate the steering wheel 16 about the longitudinal central axis 24 of the steering column assembly 18 to effect turning movement of the steerable vehicle wheels 12 and 14 in a known manner. During rotation of the steering wheel to turn the steerable vehicle wheels 12 and 14, the electronic control unit 54 does not energize the electric motors 60 and 72. Therefore, telescopic and/or tilt adjustments can not be made to the steering column assembly 18 during steering of the vehicle.

When the vehicle is stopped and the control switch 84 has been actuated, the driver of the vehicle may push or pull on the steering wheel 16 to effect a telescopic adjustment in the steering column assembly 18, or a tilt adjustment in the steering column assembly or a combination of a tilt and telescopic adjustment in the steering column assembly. Thus, the motor 60 may be energized to effect only a change in the telescopic relationship between the inner and outer members 32 and 34 of the steering column 18.

Alternatively, only the motor 72 may be energized to effect pivotal movement of the upper steering column member 42 about an axis extending perpendicular to the central axis 24 of the steering column at the pivot joint 44. Alternatively, if a combination of forces are manually applied to the steering wheel 16 by the operator of the vehicle, the motor 60 may be energized to change the position of the steering wheel 16 along the axis 24 while the motor 38 is energized to change the angular orientation of the steering wheel relative to the axis 24.

It is contemplated that the inner and outer steering column members 32 and 34 and the upper steering column member 42 may be interconnected in the same manner as is disclosed in U.S. Pat. No. 5,711,189. Of course, the steering column members 32, 34 and 42 may interconnected in a manner which is different than disclosed in U.S. Pat. No. 5,711,189.

The steering column assembly 18 may also be automatically adjusted to a pre-selected position as a function of the weight of an operator seated on the driver's seat 100. In particular, referring to FIG. 2, the apparatus 10 includes a weight sensor 102 mounted in a mounting structure for the driver's seat 100 of the vehicle. The weight sensor 102 can be any known device including, but not limited to, strain gages, piezoelectric devices etc., that may determine weight directly or by inference. The weight sensor 102 senses the combined weight of the driver's seat 100 and the portion of the weight of a vehicle occupant supported by the driver's seat 100. The weight sensor 102 provides an output signal, which is a function of the weight of a person seated on the driver's seat 100.

The weight sensor 102 is mounted in a mounting structure for the driver's seat 100. The weight sensor 102 may be disposed above or below seat position adjustment rails on which the driver's seat is disposed. Alternatively, the weight sensor 102 may be disposed in the driver's seat 100. If the weight sensor 102 is disposed in the driver's seat 100, the weight sensor may be an inflated bladder, a piezoelectric device, strain gauge, or other device which senses force applied against the seat by the weight of the driver.

The weight sensor 102 provides the output signal over a lead wire 104 to the controller 54. The apparatus 10 includes a memory 55, which may be part of the controller 24.

A rotary telescope potentiometer 106 is operatively connected to the telescope actuator 28. The telescope potentiometer 106 is adjusted by movement of the outer member 34 along the longitudinal central axis 24 of the steering column 18. Therefore, the telescope potentiometer 106 is adjusted during the movement of the steering wheel 16 in a direction either toward the operator of the vehicle or away from the operator of the vehicle. The telescope potentiometer 106 provides an output signal to the controller 54 indicative of the telescopic position of the steering wheel 16.

A rotary tilt potentiometer 108 is operatively connected to the tilt actuator 38. The tilt potentiometer 108 is adjusted by the pivotal movement of the upper steering column member 42 about the pivot joint 44. Therefore, the tilt potentiometer 108 is adjusted during movement of the steering wheel 16 in a tilting direction relative to the longitudinal central axis 24 of the steering column assembly 18. The tilt potentiometer 108 provides an output signal to the controller 54 indicative of the tilt position of the steering wheel 16.

A memory set button 53 is connected to the controller 54. Upon manual actuation of the memory set button 53, data corresponding to output signals from the telescope potentiometer 106, the tilt potentiometer 108, and the weight sensor 102 is stored in the memory 55. This enables the controller 54 to associate the weight of a particular individual with specific telescope and tilt positions of the steering wheel 16. A memory clear button 67 is connected to the controller 54. Upon actuation of the memory clear button 67, all data stored in the memory 55 corresponding to output signals from telescope potentiometer 106, the tilt potentiometer 108, and weight sensor 102 is erased from the memory 55.

In operation, a first operator having a weight W₁ sits in the driver's seat 100 and manually adjusts the steering column assembly 18 to move the steering wheel 16 to desired tilt and telescope positions as previously discussed. Also, the seat weight sensor 102 senses the first operator's weight W₁ on the seat 100 and outputs a signal that is a function of the first operator's weight to the controller 54. The first operator then depresses the memory set button 53 to store the steering wheel tilt and telescope positions and corresponding weight associated with the first operator in the memory 55. When the first operator reenters the vehicle and sits upon the driver's seat 100, the seat weight sensor 102 senses the increased weight on the seat and sends the output signal indicative of the previously sensed weight for the first operator to the controller 54.

Then, the first operator actuates the control switch 84. Upon actuation of the control switch 84, the controller 54 compares the sensed weight with the weight value(s) stored in the memory 55. When the comparison indicates a weight value stored in the memory 55, the controller 54 outputs a control signal to the telescope and tilt actuators 28, 38, which adjust the steering column assembly 18 to move the steering wheel 16 to the pre-selected position that corresponds to the weight value stored in the memory 55.

The apparatus 10 can also automatically adjust the steering column assembly 18 to move the steering wheel 16 to a desired position for a second operator with a weight different than that for the first operator. To accomplish this operation, the second operator sits in the seat 100 and manually adjusts the steering column assembly 18 to locate the steering wheel in a desired position as previously discussed. The seat weight sensor 102 senses a weight resulting from the second operator sitting on the seat 100. The weight sensor 102 outputs a signal which is a function of the second operator's weight W₂ to the controller 55.

The second operator then depresses the memory set button 53 to store the desired steering wheel positions and the sensed weight associated with the second operator in the memory 55. When the second operator reenters the vehicle and sits upon the driver's seat 100, the seat weight sensor 102 senses the increased weight on the seat and sends the output signal which is a function of the weight of the second operator to the controller 54. Then, the second operator actuates the control switch 84. Upon actuation of the control switch 84, the controller 54 compares the sensed weight with the weight values stored in the memory 55. When the comparison indicates a corresponding similar weight value stored in the memory 55, the controller 54 outputs a control signal to the telescope and tilt actuators 28, 38, which adjust the steering column assembly 18 to move the steering wheel 16 to the pre-selected position that corresponds to the second operator.

In like manner, the apparatus 10 can automatically adjust the steering wheel position for any number of additional operators based on their weight. If desired, the manually actuated control switch 84 may be omitted so that the steering column assembly 18 can be automatically adjusted to move the steering wheel 16 to the pre-selected position upon the operator sitting in the seat 100.

Alternatively, instead of the control switch 84, a vehicle ignition switch 110 may be used to cause the controller 54 to automatically adjust the steering column assembly 18 to move the steering wheel 16 to the pre-selected position. Specifically, the ignition switch 110 is coupled to the controller 54 and outputs a signal indicative of the vehicle being turned on. The ignition switch provides the output signal over a lead wire 112 to the controller 54. When the operator turns on the ignition switch 110, the output signal from the ignition switch 110 causes the controller 54 to output a control signal to the telescope and tilt actuators 28, 38, which adjust the steering column assembly 18 to move the steering wheel 16 to the pre-selected position.

In another alternative version, the vehicle door switch 114 is used in lieu of the control switch 84 to cause the controller 54 to automatically adjust the steering column assembly 18 to move the steering wheel 16 to the pre-selected position. In particular, the door switch 114 is electrically coupled to the controller and outputs a signal indicative of the driver's door being open. The door switch 114 provides the output signal over a lead wire 116 to the controller 54. When the operator opens the driver's door to enter the vehicle, the door switch 114 outputs the signal to the controller 54, which in turn outputs a control signal to the telescope and tilt actuators 28, 38, which adjust the steering column assembly 18 to move steering wheel 16 to the pre-selected position.

Alternatively, the tilt and telescopic actuators can be actuated by push buttons to manually adjust the steering column assembly rather than the force sensors, which are actuated by the manual application of force to the steering wheel. Further, a second control switch can be used instead of the control switch 84 to cause the controller 54 to automatically adjust the steering column assembly 18 to move the steering wheel 16 to the pre-selected position based on the weight of the operator.

Also, the controller can be programmed to output a control signal to the telescope and tilt actuators 28, 38 to adjust the steering column assembly 18 to move the steering wheel 16 to the pre-selected position, when the comparison of the sensed weight value with the weight value(s) stored in the memory 55 is within a specific range of the corresponding weight value stored in the memory 55. This feature would allow the steering column to adjust the steering wheel to the pre-selected position set for a driver in the event that the driver's weight should change slightly.

From the above description of the invention, those skilled in the art will perceive improvements, changes and modifications. Such improvements, changes and modifications within the skill of the art are intended to be covered by the appended claims.

Having described the invention, the following is claimed:

1. An apparatus for adjusting the position of a steering wheel connected with a steering column assembly, said apparatus comprising:
an actuating system operatively connected to the steering column assembly, said actuating system being operable to adjust the steering column assembly to change the position of the steering wheel, said actuating system being operable to move the steering wheel along a central axis of the steering column assembly and operable to tilt the steering wheel relative to the central axis of the steering column assembly;
at least one weight sensor operatively associated with a driver's seat for sensing a driver's weight on the seat, said weight sensor outputting a signal which is a function of the driver's weight;
a controller operatively connected to said weight sensor and said actuating system, said controller being operable to provide a control signal to said actuating system to effect operation of said actuating system to adjust the steering column assembly and change the axial position and tilt position of the steering wheel as a function of a signal from said weight sensor.

2. The apparatus of claim 1 including a memory set button, said memory set button being actuable to store in the controller an item corresponding to a weight on the seat and an item corresponding to a position of the steering wheel column.

3. The apparatus of claim 1 wherein said actuating system includes first and second actuators, said first actuator being actuable to tilt the steering wheel relative to the central axis of the steering column assembly, said second actuator being actuable to move the steering wheel along the central axis of the steering column assembly.

4. The apparatus of claim 1 including means for preventing operation of said actuating system when the vehicle is in motion.

5. The apparatus of claim 1 wherein said controller includes a memory, said memory storing data corresponding to a pre-selected steering wheel position and a predetermined weight on the driver's seat, said controller outputs a control signal to said actuating system to adjust the position of said steering wheel to said pre-selected steering wheel position upon said weight sensor sensing a weight on the driver's seat that corresponds to the predetermined weight stored in said memory.

6. The apparatus of claim 5 wherein said memory stores another pre-selected steering wheel position and another predetermined weight on the driver's seat, said controller outputs a control signal to said actuating system to adjust the position of said steering wheel to said another pre-selected steering wheel position upon said weight sensor sensing a weight on the driver's seat that corresponds to the another predetermined weight stored in said memory.
